(19) United States
(12) Patent Application Publication
(10) Pub. No.: US 2026/0061453 A1
(43) Pub. Date: Mar. 5, 2026

(54) Apparatus for Applying a Flowable Material to an Inner Wall of a tube

(71) Applicant: Henkel AG & Co. KGaA, Düsseldorf (DE)

(72) Inventors: ZhongHua Zhang, Shanghai (CN); ChengYu Wang, Shanghai (CN); Ji Feng, Shanghai (CN)

(21) Appl. No.: 19/385,345

(22) Filed: Nov. 11, 2025

Related U.S. Application Data
(63) Continuation of application No. PCT/CN2023/097132, filed on May 30, 2023.

(51) Int. Cl. B05C 7/02; B05C 11/10; F16L 55/44; F16L 101/16

(52) U.S. Cl. CPC B05C 7/02; B05C 11/1002; F16L 55/44; F16L 2101/16

(57) ABSTRACT

The present disclosure generally relates to an apparatus for applying a flowable material to an inner wall of a tube (600), comprising: a controller (100), a source device (200), and a motion driving device (300) which are outside the tube (600); and a motion and operation device (400) releasably insertable into the tube (600), the source device (200) is configured to selectively feed the flowable material to the motion and operation device (400) under control of the controller (100), the motion and operation device (400) comprises a spray cup (463) such that when the spray cup (463) is rotated, the flowable material fed into the spray cup (463) can be radially spun out of the spray cup (463), the motion driving device (300) is configured to enable the motion and operation device (400) to be movable in the tube (600) when it is inserted in the tube (600).

### FIELD

The present disclosure generally relates to an apparatus for applying a flowable material to an inner wall of a tube.

### BACKGROUND

In industries, tubes sometimes need to be coated with a rubber material on their inner walls. In this case, it is required to first apply a flowable adhesive material onto the inner walls. Especially, the flowable adhesive material could be a solvent-free adhesive material which can be cured at room temperature. Such a solvent-free adhesive material, before being applied, is usually formed by mixing two flowable components, and may have a high viscosity and a short pot life.

Therefore, in the prior art, in order to solve challenges caused by the high viscosity and the short pot life, a high pressure adhesive feeding system with a heater has to be used such that an inner wall of a tube could be coated with the solvent-free adhesive material. However, such a system sometimes is not available at most working sites and even results in much inconvenience. Moreover, the applying work has to be manually carried out by means of a brush, usually resulting in non-uniformity of the adhesive coating on the inner wall of the tube. If the tube is longer and/or its diameter is not great enough, it will be very difficult for the operator to manually carry out the applying work. Moreover, the manual applying work is time-consuming, during which the operator cannot directly observe how the inner wall of the tube is coated with the adhesive material. Besides, sometimes the mixed flowable material may be toxic for human such that the operator's health is impaired when he/she is coating the tube with the mixed flowable material by the brush.

### SUMMARY

In order to solve the issues existing in the prior art, the present disclosure is aimed at proposing a novel apparatus for applying a flowable material, especially a solvent-free adhesive material or any flowable material having a high viscosity and/or a short pot life, to an inner wall of a tube, such that pre-curing of the flowable material prior to being applied is avoided, the material could be coated uniformly and safely on the inner wall of the tube, unnecessary material waste is reduced, and the applying process can be directly observed.

According to an aspect, the present disclosure proposes an apparatus for applying a flowable material to an inner wall of a tube, comprising:
a controller, a source device, and a motion driving device which are outside the tube; and
a motion and operation device releasably insertable into the tube, the source device is configured to selectively feed the flowable material to the motion and operation device under control of the controller, the motion and operation device comprises a spray cup such that when the spray cup is rotated, the flowable material fed into the spray cup can be radially spun out of the spray cup, the motion driving device is configured to enable the motion and operation device to be movable in the tube when it is inserted in the tube.

In an embodiment, the motion and operation device comprises a foldable frame which is switchable between a folded state and an extended state or is able to stay in a state between the folded state and the extended state, to be adaptable to pipes of diameters which are in a range, the minimum diameter of the range is defined by the peripheral contour of the foldable frame in its cross section in the folded state, and the maximum diameter of the range is defined by the peripheral contour of the foldable frame in its cross section in the extended state.

In an embodiment, the foldable frame comprises a middle platform, two foldable assemblies provided respectively at either lateral side of the middle platform and mirror-symmetrically relative to the middle platform, and several cross rods configured to connect the two foldable assemblies together.

In an embodiment, the spray cup is provided on the middle platform longitudinally beyond the foldable assemblies.

In an embodiment, the motion and operation device comprises a camera installed on the middle platform for capture live images or video of the interior of the tube when the foldable frame is in the tube and the captured images and video can be conveyed to the controller for observation or record.

In an embodiment, the motion and operation device comprise a LED light installed on the middle platform aside the camera.

In an embodiment, the motion and operation device comprise a mixer adapter provided on the middle platform longitudinally opposite to the spray cup, the flowable material is first fed into the mixer adapter and then into the spray cup.

In an embodiment, the mixer adapter is provided with at least two ports for receiving at least two different material components.

In an embodiment, the flowable material is a solvent-free adhesive material formed by mixing two adhesive components.

In an embodiment, each foldable assembly comprises a first arm, a second arm, a third arm and a fourth arm, the first arm and the second arm are hinged to each other at a first hinging point to form an X-shape; the third arm and the fourth arm are hinged to each other at a second hinging point, the second arm and the fourth arm are hinged to the platform at a third hinging point which is immovable relative to the platform, and the first arm and the third arm are hinged to each other at a fourth hinging point which is slidable in a straight slot is formed in a lateral side of the platform.

In an embodiment, in the folded state, the fourth hinging point is moved in the straight slot to a location farthest away from the third hinging point and the first and second hinging points are moved to a location closest to the platform; in the extended state, the fourth hinging point is moved in the straight slot to a location closest to the third hinging point and the first and second hinging points are moved to a location farthest away from the platform.

In an embodiment, a spring element is provided between the third arm and the fourth arm and/or between the first arm and the second arm, to apply a force to the foldable frame to urge it to be returned from the folded state to the extended state.

In an embodiment, the motion driving device is a winch device comprising a rotatable winding shaft, a rope is releasably tie between the foldable frame and the winding shaft such that when the rope is wound around the winding shaft which is rotating, the foldable frame can be dragged by the rope to move in the tube.

In an embodiment, the rotating speed of the spray cup, and/or the rotating speed of the winding shaft, and/or the feeding speed of the flowable material is adjustable.

Using the technical measures of the present disclosure, the flowable material can be readily applied onto the inner wall of the tube even if the flowable material has a high viscosity and a short pot life. During application of the flowable material within the tube, a user can stay safely because he/she will not contact the tube. Moreover, since the application of the flowable material is completed by the apparatus only (no human laboring being required for applying the flowable material), the applied layer can be more uniform. More importantly, the whole applying process can be clearly monitored by the camera and thus relevant operating parameters can be real-timely adjusted to ensure the quality of the applied layer.

### BRIEF DESCRIPTION OF THE DRAWINGS

The principles and the other aspects of the present disclosure will be explained in the following description with reference to the drawings. In the drawings of the present disclosure, the features having the same configuration or same functions may be represented by the same reference numerals respectively.

FIG. 1 is a system chart schematically illustrating an apparatus for applying a flowable material to an inner wall of a tube according to an embodiment of the present disclosure;

FIG. 2A is a front view schematically illustrating a controller according to an embodiment of the present disclosure which is as a part of the apparatus of FIG. 1;

FIG. 2B is a side view schematically illustrating the controller of FIG. 2A;

FIG. 3 is a perspective view schematically illustrating a winch device according to an embodiment of the present disclosure which is as a part of the apparatus of FIG. 1;

FIG. 4A is a front view schematically illustrating a motion and operation device according to an embodiment of the present disclosure which is as a part of the apparatus of FIG. 1;

FIG. 4B is a side view schematically illustrating the motion and operation device of FIG. 4A;

FIG. 4C is a perspective view schematically illustrating the motion and operation device;

FIGS. 5A to 5C show how the apparatus according to the present disclosure is used to apply a flowable material onto an inner wall of a tube.

### DETAILED DESCRIPTION OF EMBODIMENTS

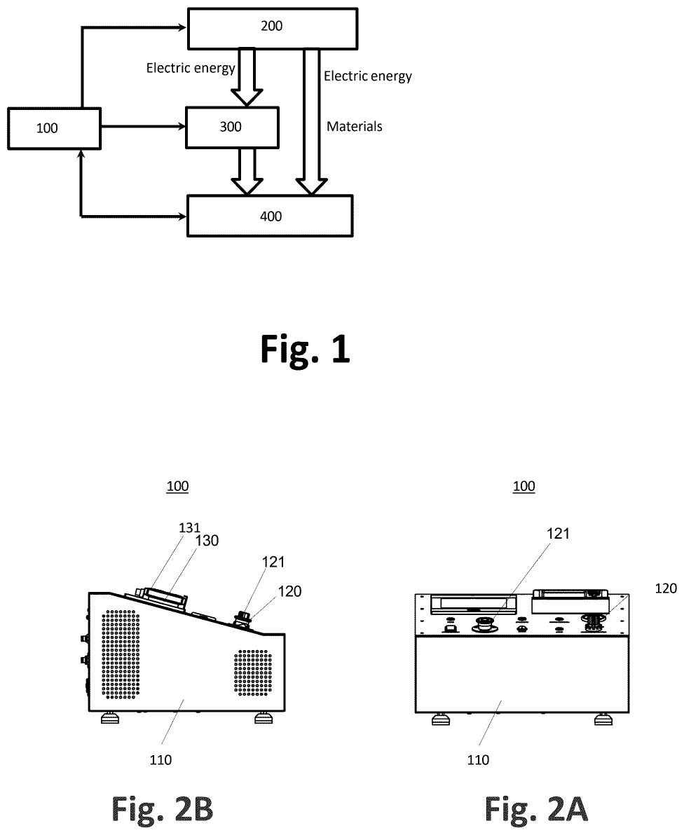

As show by FIG. 1, an apparatus for applying a flowable material to an inner wall of a tube according to an embodiment of the present disclosure generally comprises a controller 100, a source device 200, a motion driving device 300 and a motion and operation device 400. As an example, the source device 200 comprises a power supply (not shown here) and a material component source (not shown here). The power supply of the source device 200 can be connected to the motion driving device 300 and/or the motion and operation device 400 via electrical cables such that electrical energy could be selectively supplied to the motion driving device 300 and/or the motion and operation device 400 under control of the controller 100. Additionally, the material component source is connected to the motion and operation device 400 via one or two or more hoses (not shown here) such that one or more material components could be conveyed to the motion and operation device 400 through the hoses. According to the present disclosure, the conveyed components can be any flowable material components. In the following description of the present disclosure, adhesive components will be taken as a non-limited example of the material components. For instance, two different adhesive components (solvent-free) could be conveyed through different hoses from the material component source of the source device 200. The two different adhesive components could be stored in two different cartridges of the material source. The material source is provided with a pump such that operation of the pump can discharge the different adhesive components out of the cartridges.

However, it should be understood by a person skilled in the art that the apparatus already described can be supplied with any flowable material or material component. The motion driving device 300 is configured to drive the motion and operation device 400 to move as desired in the tube when the flowable material is being applied to the inner wall of the tube. In an embodiment of the present disclosure, the motion driving device 300 can be in the form of a winch device which can be selectively coupled to the motion and operation device 400 via a rope such that the motion and operation device 400 can be dragged to move by winding the rope.

As shown by FIGS. 2A and 2B, the controller 100 comprises a housing 110 in which at least a printed circuit board is installed. On the printed circuit board some electronic devices and an electric control unit necessary for controlling operation of the source device 200 and/or the motion driving device 300 and/or the motion and operation device 400 are arranged. In order to dissipate heat caused by the electronic devices and the electric control unit, some holes are formed in the housing 110. Besides, display screens 130 and 131, knobs 120, 121 and buttons (only one of the buttons is represented by a reference numeral “122” in FIG. 2A) are provided on the housing 110 to set operating parameters of the source device d200 and/or the motion driving device 300 and/or the motion and operation device 400, for example activation or deactivation of the pump of the source device 200, electric energy supplying of the source device 200 or not, and so on.

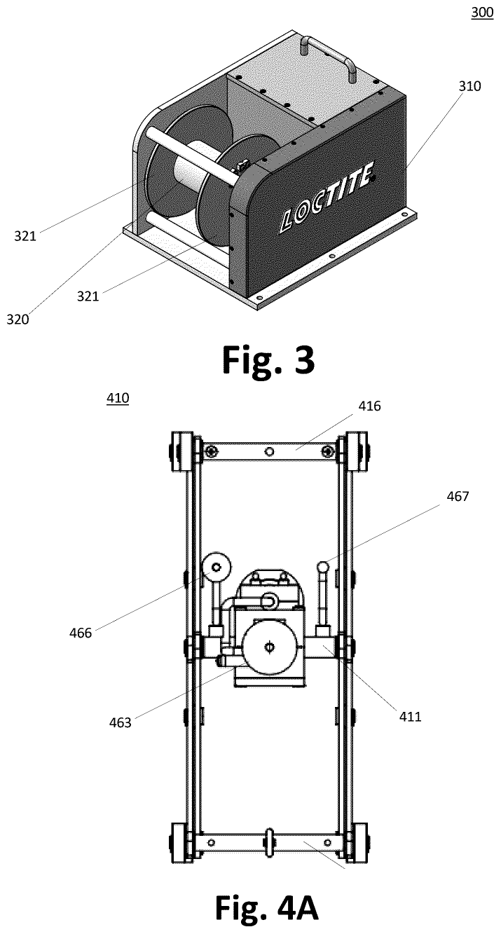

As shown by FIG. 3, the winch device 300 comprises a housing 310 in which an electric motor (hidden in FIG. 3) is installed. The winch device 300 also comprises a winding shaft 320 rotatably installed in the housing 310. Two block discs 321 are provided on the winding shaft 320 such that one end of the rope for dragging the motion and operation device 400 can be releasably tied to the winding shaft 320 between the blocking discs 321. The winding shaft 320 has a diameter which is less than a diameter of the blocking discs 321 such that when the winding shaft 320 is rotated, the rope can be wound on and/or around the winding shaft 320 only between the blocking discs 321. The winding shaft 320 is coupled to the electric motor via a belt or gear-box transmission or any other suitable transmission. The rotating speed of the winding shaft 320 can be adjusted by the controller 100, for example by manipulating the knobs 120, 121 or the buttons 122 of the controller 100 such that the output power of the electric motor could be modified.

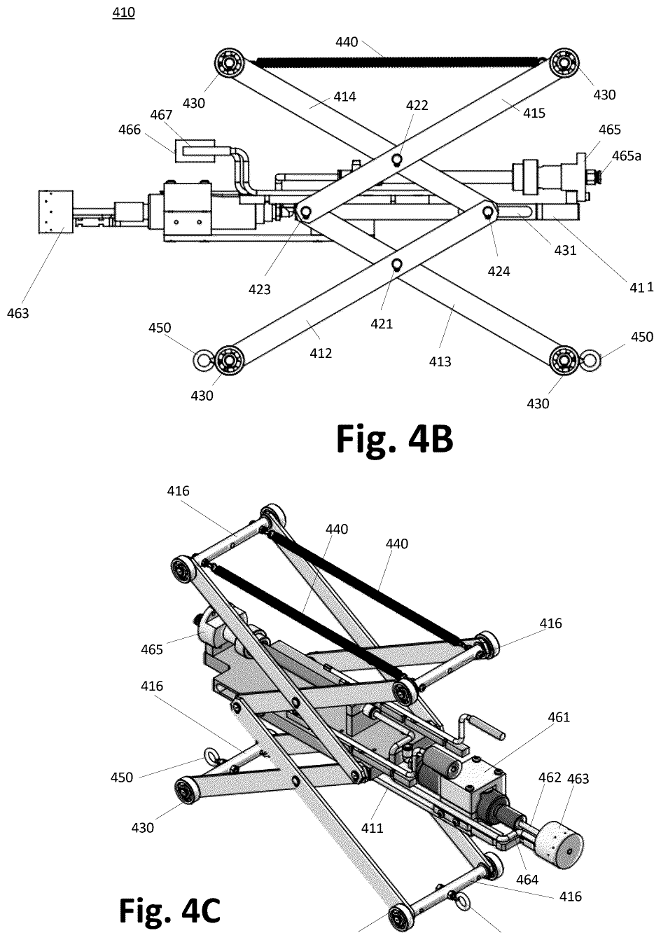

As shown by FIGS. 4A, 4B and 4C, according to an embodiment of the present disclosure, the motion and operation device 400 comprises a foldable frame 410. In the shown embodiment, the foldable frame 410 generally comprises a middle platform 411, two foldable assemblies which are provided respectively at either lateral side of the middle platform 411, and several cross rods (for example four cross rods 416 shown) configured to connect the two foldable assemblies together. As the two foldable assemblies are provided mirror-symmetrically relative to the middle platform 411, only one of the two foldable assemblies will be described below. It should be understood by a person skilled in the art that the described contents of the one foldable assembly naturally applies to the other foldable assembly. As shown by FIG. 4B, one assembly comprises four arms, i.e., a first arm 412, a second arm 413, a third arm 414 and a fourth arm 415. In the shown embodiment, the first arm 412 and the second arm 413 are hinged to each other at a hinging point 421 to form an X-shape; the third arm 414 and the fourth arm 415 are hinged to each other at a hinging point 422. The second arm 413 and the fourth arm 415 are hinged to the platform 411 at a hinging point 423, and the first arm 412 and the third arm 414 are hinged to each other at a hinging point 424 which is slidable in a straight slot s formed in a lateral side of the platform 411. A free end of the first arm 412 opposite to the hinging point 424 of one foldable assembly is connected to a corresponding free end of the first arm (invisible in FIG. 4B) of the other foldable assembly by one cross rod 416. For example, the cross rod 416 is free-pivotally connected to both free ends of the first arms. A free end of the second arm 413 opposite to the hinging point 423 of one foldable assembly is connected to a corresponding free end of the second arm (invisible in FIG. 4B) of the other foldable assembly by another cross rod 416. For example, the cross rod 416 is free-pivotally connected to both free ends of the second arms. A free end of the third arm 414 opposite to the hinging point 424 is connected to a corresponding free end of the third arm (invisible in FIG. 4B) of the other foldable assembly by another cross rod 416. For example, the cross rod 416 is free-pivotally connected to both free ends of the third arms. A free end of the fourth arm 415 opposite to the hinging point 423 of one foldable assembly is connected to a corresponding free end of the fourth arm (invisible in FIG. 4B) of the other foldable assembly by another cross rod 416. For example, the cross rod 416 is free-pivotally connected to both free ends of the fourth arms. The existence of the four cross rods 416 enables the two foldable assemblies to be movable synchronously.

Among the four hinging points 421, 422, 423, and 424 of the shown foldable assembly, only the hinging point 424 is slidable relative to the platform 411 and the hinging point 423 is immovable relative to the platform 411, the hinging points 421 and 422 locate at opposing faces of the flatform 411 respectively. Due to this specific design, the foldable frame 410 is switchable between a folded state and an extended state. In the folded state, the hinging point 424 is moved in the straight slot 431 to a location farthest away from the hinging point 423 and the hinging points 421 and 422 are moved to a location closest to the platform 411. Contrarily, in the extended state, the hinging point 424 is moved in the straight slot 431 to a location closest to the hinging point 423 and the hinging points 421 and 422 are moved to a location farthest away from the platform 411. Wheels 430 are rotatably installed at opposing ends of each cross rod 416. When the foldable frame 410 is moved in the tube, it contacts the inner wall of the tube via all wheels 430 thereof. A pair of spring elements 440 are provided between the cross rods 416 of the third arms 414 and the fourth arms 415. For example, one of the pair of spring elements 440 is provided adjacent to the wheels 430 of the third arm 414 and the fourth arm 415 of one foldable assembly, and the other of the pair of spring elements 440 is provided adjacent to the wheels of the third arm 414 (invisible in FIG. 4B) and the fourth arm 415 (invisible in FIG. 4B) of the other foldable assembly. Alternatively or additionally, a pair of spring elements can be provided in a similar manner between the cross rods 416 of the first arms 412 and the second arms 413. The spring elements are used to always urge the foldable frame 410 to be returned from its folded state to its extended state. Therefore, the spring elements 440 enable the foldable frame 410, when is inserted in a tube in a state between the folded state and the extended state, to stably contact an inner wall of the tube. It is understood by a person skilled in the art that the folded and extended states of the foldable frame 410 causes that it can be inserted into pipes of diameters which are in a given range. The minimum diameter of the range is defined by the peripheral contour of the foldable frame 410 in its cross section in the folded state, and the maximum diameter of the range is defined by the peripheral contour of the foldable frame 410 in its cross section in the extended state.

The foldable frame 410 or the foldable assemblies thereof are configured such that no matter when the foldable frame 410 is inserted in a tube in the state between the folded state and the extended state, the middle platform 411 is always held in a middle plane of the tube or slightly offset to it. Even when the foldable frame 410 is moved in the tube, the middle platform 411 is always in the middle plane of the tube or slightly offset to it. For instance, when the foldable frame 410 is inserted into a tube, the cross rods 416 of the first arms 412 and the second arms 413 can be below the cross rods 416 of the third arms 414 and the fourth arms 415. In an embodiment, each of the cross rods 416 of the first arms 412 and the second arms 413 is provided with a retaining ring element 450. A rope can be tied onto the retaining ring element 450. In an alternative or additional embodiment, each of the cross rods 416 of the third arms 414 and the fourth arms 415 is provided with a similar retaining ring element.

On the platform 411, a motor 461 is installed. In a preferred embodiment, the motor 461 is a pneumatic motor 461. A rotatable shaft 462 extends out of the motor 461. The rotatable shaft 462 has an end which goes beyond the cross rods 416 viewed in a side view like FIG. 4B. The foldable frame 410 is configured such that when it is inserted into a tube, the end of the rotatable shaft 462 always goes longitudinally beyond the cross rods 416 adjacent thereto. A spray cup 463 is secured on the end of the rotatable shaft 462 in such a way that an opening of the spray cup 463 always faces towards the motor 461. In a preferred embodiment, the foldable frame 410 is configured in such a way that when it is inserted into a tube, the rotatable shaft 462 substantially coincides with the central axis of the tube. The end of the rotatable shaft 462 is secured to a bottom side of the spray cup 463 at its center. When the foldable frame 410 is inserted into a tube and the shaft 462, as an output shaft of the motor 461, is rotated, the spray cup 463 also rotates about the central axis of the tube.

On the platform 411, at a location longitudinally opposite to the spray cup 463, a mixer adapter 465 is provided. Take a two-component composition adhesive for example. The mixer adapter 465 is provided with two ports 465a and 465b (only the port 465a is visible in FIG. 4B). The two ports 465a and 465b of the mixer adapter 465 are configured to be connected to the material component source by two hoses (not shown) respectively. In the material component source, two different adhesive components are stored. After the adhesive components conveyed through the hoses are fed into the ports 465a and 465b, they will mix with each other in an interior space of the mixer adapter 465. Thereafter, the mixed material will be discharged through a pipe 464 from the mixer adapter 465. The pipe 464 is arranged on the platform 411 such that the pipe 464 is bent several times. The pipe 464 has an opening which locates in a hollow space of the spray cup 463. In a circumferential wall of the spray cup 463, a plurality of through holes are formed (as shown by FIG. 4C). Therefore, when the spray cup 463 rotates like described above, the mixed material discharged out of the opening of the pipe 464 will fall in the spray cup 463 and then under a centrifugal force caused by the rotation of the spray cup 463, will be spun radially through the holes of the spray cup 463 out of the same.

Since the spray cup 463 is longitudinally out of the wheels 430 adjacent thereto when the foldable frame 410 is inserted in a tube, the spun mixed material can be uniformly and directly applied onto an inner wall of the tube. Besides, as the adhesive components are not mixed with each other until it is conveyed to the mixer adapter 465 of the motion and operation device 400, potential challenges caused by a high viscosity and/or a short pot life of the mixed adhesive if having will be perfectly solved. A length of the pipe 464 is selected such that the mixed adhesive will not be pre-cured before it is spun out of the spray cup 465.

A camera 466 is provided on the platform 411 and configured to capture live images or video of the interior of the tube when being coated with the mixed adhesive or material. The camera 466 of the motion and operation device 400 is connected to the controller 100 via a cable such that a user can real-timely observe the interior of the tube via the display screen 130 or 131 of the controller 100 to determine whether the coating effect has met requirements and/or modify relevant operating parameters such as the rotating speed of the spray cup 465, the moving speed of the foldable frame 410 or the like. A LED light 467 is provided on the platform 411 and configured to illuminate the interior of the tube.

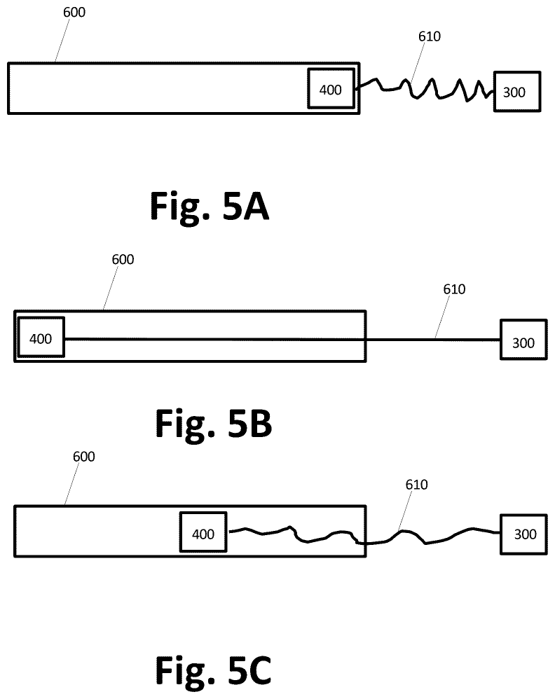

FIGS. 5A to 5C show an example of a process in which the apparatus according to the present disclosure is used to apply a two-component composition adhesive onto an inner wall of a tube 600. In the shown example, the tube 600 is a straight tube. For clarity, only the motion and operation device 400 and the winch device 300 of the apparatus are shown. First, the foldable frame 410 is manually fold and kept into a state in which the foldable frame 410 can be inserted into the tube 600. Thereafter, a rope (not shown) is tied to a retaining ring element 450 of the foldable frame 410 adjacent to the spray cup 463. Besides, another rope 610 is tied between a retaining ring element 450 of the foldable frame 410 faraway from the spray cup 463 and the winding shaft 320 of the winch device 300. By manually dragging the not-shown rope, the foldable frame 410 of the motion and operation device 400 can be moved from a position in one end of the tube 600 as shown by FIG. 5A to a position in the other opposite end of the tube 600 as shown by FIG. 5B. Then, the not-shown rope is released from the foldable frame 410. The user can operate the controller 100 (not shown in FIGS. 5A to 5C) such that the electric motor of the winch device 300 is activated to rotate the winding shaft 320 and thus the rope 610 is wound around the winding shaft 320. At the same time, the user can operate the controller 100 such that the spray cup 463 is rotated and adhesive components are fed into the mixer adapter 465, mixed there, and discharged into the rotating spray cup 463 via the pipe 464. In this way, the mixed and still flowable adhesive can be spun out of the spray cup 463 through the holes thereof, and applied onto the inner wall of the tube 600. After the foldable frame 410 is dragged by the rope 610 to move along the entire length of the tube 600, the adhesive can be uniformly applied onto the inner wall of the tube 600. Using the apparatus according to the present disclosure, it is not necessary for the user to stay close to the tube 600. The user can operate the controller 100 at a location far away from the tube 600 whose inner wall is being coated with the adhesive such that his or her healthy is guaranteed. Besides, by operating the controller 100, the user can modify the rotating speed of the spray cup 463, the moving speed of the foldable frame 410 in the tube 600, the feeding speed of the adhesive components to control the quality of the applied adhesive layer on the inner wall of the tube 600.

Although in the embodiment shown by FIGS. 5A to 5C the tube 600 is a straight tube, it can be a curved tube as soon as the curvature of the curved tube does not affect free movement of the foldable frame 410 in the curved tube.

Although some specific embodiments and/or examples of the present disclosure are described here, they are given for illustrative purposes only and cannot be deemed to constrain the scope of the present disclosure in any way. Furthermore, it should be understood by a skilled person in the art that the embodiments and/or examples described here can be combined with each other. Without departing from the spirit and scope of the present disclosure, various replacements, modifications, and alternations can be carried out.

1. An apparatus for applying a flowable material to an inner wall of a tube (600), comprising:
a controller (100), a source device (200), and a motion driving device (300) which are outside the tube (600); and
a motion and operation device (400) releasably insertable into the tube (600), the source device (200) is configured to selectively feed the flowable material to the motion and operation device (400) under control of the controller (100), the motion and operation device (400) comprises a spray cup (463) such that when the spray cup (463) is rotated, the flowable material fed into the spray cup (463) can be radially spun out of the spray cup (463), and the motion driving device (300) is configured to enable the motion and operation device (400) to be movable in the tube (600) when it is inserted in the tube (600).

2. The apparatus according to claim 1, wherein the motion and operation device (400) comprises a foldable frame (410) which is switchable between a folded state and an extended state or is able to stay in a state between the folded state and the extended state, to be adaptable to pipes of diameters which are in a range, the minimum diameter of the range is defined by the peripheral contour of the foldable frame (410) in its cross section in the folded state, and the maximum diameter of the range is defined by the peripheral contour of the foldable frame (410) in its cross section in the extended state.

3. The apparatus according to claim 2, wherein the foldable frame (410) comprises a middle platform (411), two foldable assemblies provided respectively at either lateral side of the middle platform (411) and mirror-symmetrically relative to the middle platform (411), and several cross rods configured to connect the two foldable assemblies together.

4. The apparatus according to claim 3, wherein the spray cup (463) is provided on the middle platform (411) longitudinally beyond the foldable assemblies.

5. The apparatus according to claim 4, wherein the motion and operation device (400) comprises a camera (466) installed on the middle platform (411) for capture live images or video of the interior of the tube (600) when the foldable frame (410) is in the tube (600) and the captured images and video can be conveyed to the controller (100) for observation or record.

6. The apparatus according to claim 5, wherein the motion and operation device (400) comprise a LED light (467) installed on the middle platform (411) aside the camera (466).

7. The apparatus according to claim 6, wherein the motion and operation device (400) comprise a mixer adapter (465) provided on the middle platform (411) longitudinally opposite to the spray cup (463), the flowable material is first fed into the mixer adapter (465) and then into the spray cup (463).

8. The apparatus according to claim 7, wherein the mixer adapter (465) is provided with at least two ports for receiving at least two different material components.

9. The apparatus according to claim 8, wherein the flowable material is a solvent-free adhesive material formed by mixing two adhesive components.

10. The apparatus according to claim 9, wherein each foldable assembly comprises a first arm (412), a second arm (413), a third arm (414) and a fourth arm (415), the first arm (412) and the second arm (413) are hinged to each other at a first hinging point (421) to form an X-shape; the third arm (414) and the fourth arm (415) are hinged to each other at a second hinging point (422), the second arm (413) and the fourth arm (415) are hinged to the platform (411) at a third hinging point (423) which is immovable relative to the platform (411), and the first arm (412) and the third arm (414) are hinged to each other at a fourth hinging point (424) which is slidable in a straight slot s formed in a lateral side of the platform (411).

11. The apparatus according to claim 10, wherein in the folded state, the fourth hinging point (424) is moved in the straight slot (431) to a location farthest away from the third hinging point (423) and the first and second hinging points (421 and 422) are moved to a location closest to the platform (411); in the extended state, the fourth hinging point (424) is moved in the straight slot (431) to a location closest to the third hinging point (423) and the first and second hinging points (421 and 422) are moved to a location farthest away from the platform (411).

12. The apparatus according to claim 10, wherein a spring element (440) is provided between the third arm (414) and the fourth arm (415) and/or between the first arm (412) and the second arm (413), to apply a force to the foldable frame (410) to urge it to be returned from the folded state to the extended state.

13. The apparatus according to claim 10, wherein the motion driving device (300) is a winch device comprising a rotatable winding shaft (320), a rope is releasably tie between the foldable frame (410) and the winding shaft (320) such that when the rope is wound around the winding shaft (320) which is rotating, the foldable frame (410) can be dragged by the rope to move in the tube (600).

14. The apparatus according to claim 13, wherein the rotating speed of the spray cup (463), and/or the rotating speed of the winding shaft (320), and/or the feeding speed of the flowable material is adjustable.
